(19) United States
(12) Patent Application Publication
(10) Pub. No.: US 2012/0096075 A1
(43) Pub. Date: Apr. 19, 2012

(54) NETWORK CONNECTION METHOD AND DEVICE BY HUMAN INTERACTION

(75) Inventors: Sangwook PARK, Gyeryong-si (KR); Noh-Sam PARK, Daejeon (KR); Jong Hyun JANG, Daejeon (KR); Hyun Chul KANG, Daejeon (KR); Eunjin KO, Daejeon (KR); Yong Mun PARK, Daejeon (KR); Hyun-Woo OH, Daejeon (KR); Bum Suk CHOI, Daejeon (KR); Mi Kyong HAN, Daejeon (KR); JaeKwan YUN, Daejeon (KR); Eun Seo LEE, Daejeon (KR); Chae Kyu KIM, Daejeon (KR); Kyeong Deok MOON, Daejeon (KR)

(73) Assignee: Electronics and Telecommunications Research Institute, Daejeon (KR)

(21) Appl. No.: 13/246,005

(22) Filed: Sep. 27, 2011

(30) Foreign Application Priority Data
Oct. 13, 2010 (KR) 10-2010-0099784

(51) Int. Cl. G06F 15/16

(52) U.S. Cl. 709/203

(57) ABSTRACT

When sensor information including user's position information, bearing information, and direction information is collected, an accessible agency list near agency sensor information is requested from the agency providing a network. When at least one accessible agency list generated based on sensor information is received from the agency, it is searched whether there is an agency satisfying sensor information from among the agencies in the list. When the agency satisfying sensor information is found, the user accesses the network through the agency to access the network of the agency according to a user direction.

### CROSS-REFERENCE TO RELATED APPLICATION

This application claims priority to and the benefit of Korean Patent Application No. 10-2010-0099784 filed in the Korean Intellectual Property Office on Oct. 13, 2010, the entire contents of which are incorporated herein by reference.

### BACKGROUND OF THE INVENTION

(a) Field of the Invention

The present invention relates to a network access terminal according to a user direction, a network providing agency, and a network access method using the same.

(b) Description of the Related Art

As wireless network infrastructures have been widely spread, users can easily access networks and receive desired services without limits of location and time. In order to access an access point that provides a network connection service, the user searches available networks to check displayed information and compare the same, and accesses the access point with an ID of the desired network or automatically accesses it according to a previous access history.

The wireless network access system is easy to install and distribute, so many access point devices are provided to and used by houses and stores. However, the user feels confused about which network he must select and access from various network lists to receive a service. Therefore, skills for accessing the access point according to the user's intention or direction are required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a network access terminal for determining a position of an access point of a network according to a user direction of the network to be accessed by the user, a network providing agency, and a network access method using the same.

An exemplary embodiment of the present invention provides a terminal for accessing a network of an agency according to a user direction, including: an information collector for collecting an agency image, agency information, and directivity information of a current user for providing an access process of an agency; a manager for managing directivity information of the user, agency information, and network information collected by the information collector; and an interface for displaying information on the agency image collected by the information collector and the agency.

Another embodiment of the present invention provides an agency for providing a network for a terminal to access according to a user direction, including: a user interface for managing current position information and contents to be provided to a terminal; a manager for managing sensor information and terminal information provided by the terminal, managing contents to be provided to the terminal, and selecting and managing a substitute agency for providing contents to the terminal; and an information provider for providing position information and bearing information of the agency to the terminal.

Yet another embodiment of the present invention provides a method for accessing a network of an agency according to a user direction, including: collecting sensor information including user's position information, bearing information, and direction information; requesting a list of accessible agencies near an agency for providing a network including the sensor information from the agency; receiving a list of at least one accessible agency generated based on the sensor information from the agency; searching whether there is an agency that satisfies the sensor information from among the agencies in the list; and accessing the network through the agency when the agency satisfying the sensor information is found.

### BRIEF DESCRIPTION OF THE DRAWINGS

FIG. 1 shows a system environment for supporting a network access service according to an exemplary embodiment of the present invention.

FIG. 2 shows a block diagram of a terminal according to an exemplary embodiment of the present invention.

FIG. 3 shows a system block diagram of an agency according to an exemplary embodiment of the present invention.

FIG. 4A to FIG. 4C show a flowchart of a network access process according to a user direction according to an exemplary embodiment of the present invention.

FIG. 5 shows an access method to a desired network in a user direction according to an exemplary embodiment of the present invention.

FIG. 6 shows an access method of a mobile agency according to an exemplary embodiment of the present invention.

FIG. 7 shows an access method to a social network supporting agency according to an exemplary embodiment of the present invention.

FIG. 8 shows an access method to an information protecting network in a user direction according to an exemplary embodiment of the present invention.

FIG. 9 shows a configuration of a GUI of a user terminal according to an exemplary embodiment of the present invention.

FIG. 10 shows a configuration of network information according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may indicate a mobile station (MS), a mobile terminal (MT), a subscriber station (SS), a portable subscriber station (PSS), user equipment (UE), and an access terminal (AT), and it may include entire or partial functions of the mobile station, the mobile terminal, the subscriber station, the portable subscriber station, the user equipment, and the access terminal.

In the specification, a base station (BS) may indicate an access point (AP), a radio access station (RAS), a node B (Node-B), an evolved Node-B (eNB), a base transceiver station (BTS), and a mobile multi-hop relay (MMR)-BS, and it may include entire or partial functions of the access point, the radio access station, the node B, the evolved Node-B, the base transceiver station, and the mobile multi-hop relay-BS.

A network access method and device according to a user direction according to an exemplary embodiment of the present invention will now be described with reference to accompanying drawings.

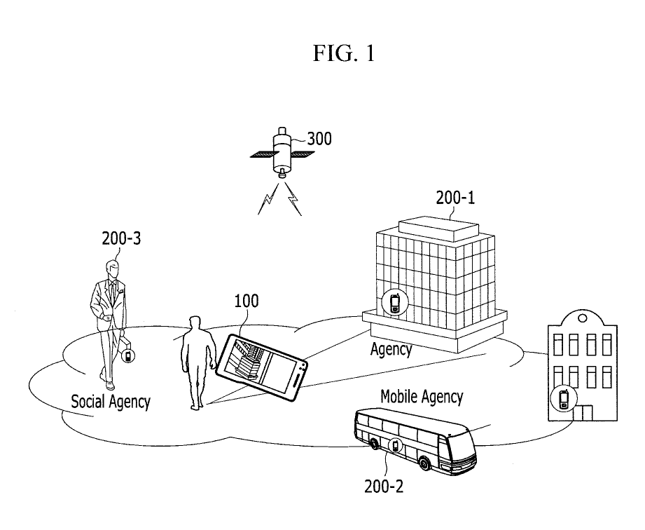

FIG. 1 shows a system for supporting a network access service according to an exemplary embodiment of the present invention.

In order to provide a network access following the user direction according to an exemplary embodiment of the present invention, the system includes a terminal 100 for checking the user's intention and an agency 200 for providing a directional network.

That is, as shown in FIG. 1, the system for supporting a network access service according to the user direction includes a plurality of agencies 200 including a network agency 200-1, a mobile agency 200-2, and a social network supporting agency 200-3, and a position information providing system 300, and under this condition, the user uses the terminal 100 to access the desired network according to the user direction.

The user uses the terminal 100 to attempt to access a specific network, and in the exemplary embodiment of the present invention, checks the agency 200 to be accessed, through an external input means such as a camera built in the terminal 100. In the exemplary embodiment of the present invention, the agencies 200 will be divided into the network agency 200-1, the mobile agency 200-2, and the social network supporting agency 200-3, and the embodiment is not restricted thereto.

The network agency 200-1 represents an agency installed in a fixed place such as an electric sign or a banner of a building, and the mobile agency 200-2 signifies an agency installed in a mobile media such as a bus. The social network supporting agency 200-3 represents an agency held and moved by the user.

When the user recognizes the network agency 200-1 installed in the electric sign or the banner of the building by using the terminal 100, the agency recognized by the terminal 100 provides access network information to the user. In this instance, the access network information includes contents information such as a publicity image of a shop at which the agency is installed, or discount events.

Also, when the user points at the medium such as the bus with the terminal 100, it can provide traffic information such as how long it takes until the next bus comes. Further, it can easily share contents (e.g., games or video) held by the users who have the social relationship through the social network supporting agency 200-3.

In this instance, to collect information such as the user's direction, a position information providing system 300 such as a global position system (GPS) is included in a system for supporting the network access service.

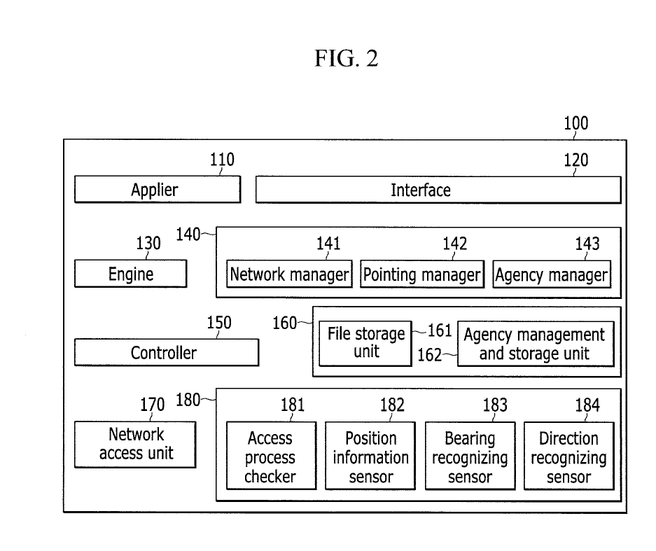

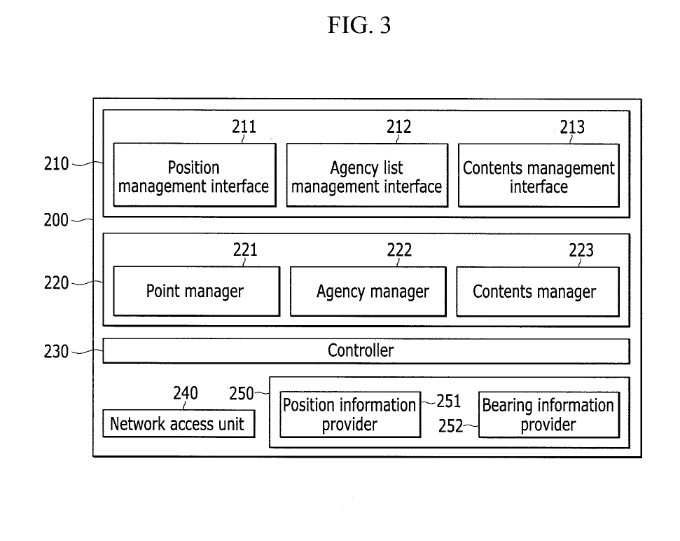

A configuration of the terminal 100 and the network agency 200 required to access the network in the user-desired direction under this system environment will now be described with reference to FIG. 2 and FIG. 3.

FIG. 2 shows a block diagram of a terminal according to an exemplary embodiment of the present invention, and FIG. 3 shows a system block diagram of an agency according to an exemplary embodiment of the present invention.

First, as shown in FIG. 2, the terminal 100 includes an applier 110, an interface 120, an engine 130, a manager 140, a controller 150, an information storage unit 160, a network access unit 170, and an information collector 180.

The applier 110 receives various contents from the agency and provides them to the user.

The interface 120 provides an agency image that is taken by a camera installed in the terminal 100 that is an information collector 180 and further provides information provided by the agency and additional information provided through the engine 130 in the agency image so that the user may easily select the desired agency and may access it.

The manager 140 for managing directivity information, agency information, and network information includes a network manager 141, a pointing manager 142, and an agency manager 143. The pointing manager 142 reads information of sensors to detect the user's directivity and manages directivity information. The pointing manager 142 includes a temporary identifier known by the terminal 100 and generated by the pointing manager 142 into a request message and broadcasts it, and decrypts all response messages encrypted and transmitted by the agency 200.

The agency manager 143 manages agency information accessible by the terminal 100. In this instance, the accessible agency information is updated and stored by the agency manager 143 each time the location of the terminal 100 is varied. When the user selects a desired agency from among candidate networks stored in the agency manager 143 through an input means (e.g., keypad) of the terminal 100, it is accepted as a request command to receive network information from the agency 200.

For this purpose, the agency manager 143 stores and manages candidate network information and accessible agency information. Here, the candidate network represents an agency represents a network positioned near the direction of the terminal 100 and providing the network accessible by the terminal 100. When the terminal 100 checks directivity of the terminal 100 to determine candidate agencies and stores information on the determined candidate agencies in the agency manager 143, it transmits a response request message to the corresponding agency to select the agency.

The network manager 141 manages the terminal 100 to access the corresponding network based on network information received by the agency manager 143 or requests a new network from the agency when there is no network candidate.

The controller 150 controls the constituent elements installed in the terminal 100.

The information storage unit 160 for storing file or agency information includes a file storage unit 161 and an agency management and storage unit 162. The file storage unit 161 receives and stores the contents received by the agency manager 143 from the agency 200. The agency management and storage unit 162 stores and controls information on the accessible agency 200. The exemplary embodiment of the present invention exemplifies independent realization of the controller 150 and the information storage unit 160, and the information storage unit 160 can be included in the controller 150.

The network access unit 170 represents a module for accessing a wireless network provided by the agency, the exemplary embodiment of the present invention uses an 802.11x module and a 3G module, and it is not restricted thereto.

The information collector 180 includes an access process checker 181, a position information sensor 182, a bearing recognizing sensor 183, and a direction recognizing sensor 184. The access process checker 181 provides an access process to the user so as to directly check the access process to the agency positioned in the direction of the terminal 100. The exemplary embodiment of the present invention uses a camera for the access process checker 181, and it is not restricted thereto.

The position information sensor 182 collects position information of the current terminal 100 from the position information providing system 300, and the bearing recognizing sensor 183 collects bearing information on the north, east, south, and west of the current terminal 100. The direction recognizing sensor 184 collects direction information of the terminal 100. Here, the bearing recognizing sensor 183 may also be called an angular velocity sensor, and an acceleration sensor may be used for a sensor for tracking the movement of the terminal 100.

As shown in FIG. 3, the system block diagram of the agency 200 for providing various services through communication with the terminal 100 shown in FIG. 2 includes a user interface 210, a manager 220, a controller 230, a network access unit 240, and an information provider 250.

The user interface 210 includes a position management interface 211, an agency list management interface 212, and a contents management interface 213. The position management interface 211 manages current position information of the agency 200, and the agency list management interface 212 manages an agency list. The contents management interface 213 sets contents to be provided to the terminal 100 and manages its operation.

The manager 220 includes a point manager 221, an agency manager 222, and a contents manager 223. The point manager 221 manages the terminal 100 for pointing the agency and pointed information for providing an interface. That is, the point manager 221 manages the terminal 100 for pointing to the agency, and when the agency providing the network receives a request message including sensor information such as a position coordinate of the terminal 100 for pointing to the agency and accessing the same from the terminal 100, the point manager 221 stores and manages information provided by the terminal 100 in advance to responding to the request message.

The agency manager 222 manages information on adjacent agencies based on current position information of the agency, and the contents manager 223 manages contents to be provided to the terminal 100 of the user. Also, when the agency is a mobile agency, the agency monitors variation of the current position information of the agency, selects a substitute agency, and transmits a cooperation request message to continuously provide the contents to the terminal 100.

The network access unit 240 connects a call between the terminal 100 and the agency so as to communicate with the terminal 100.

The information provider 250 provides position information and bearing information of the agency to the terminal 100. For this purpose, the information provider 250 includes a position information provider 251 and a bearing information provider 252. The position information and the bearing information of the agency can be collected from the position information providing system 300 in a like manner of the terminal 100, and can also be collected from a sensor (e.g., E-compass) of the agency 200.

The controller 230 controls the constituent elements including the information provider 250.

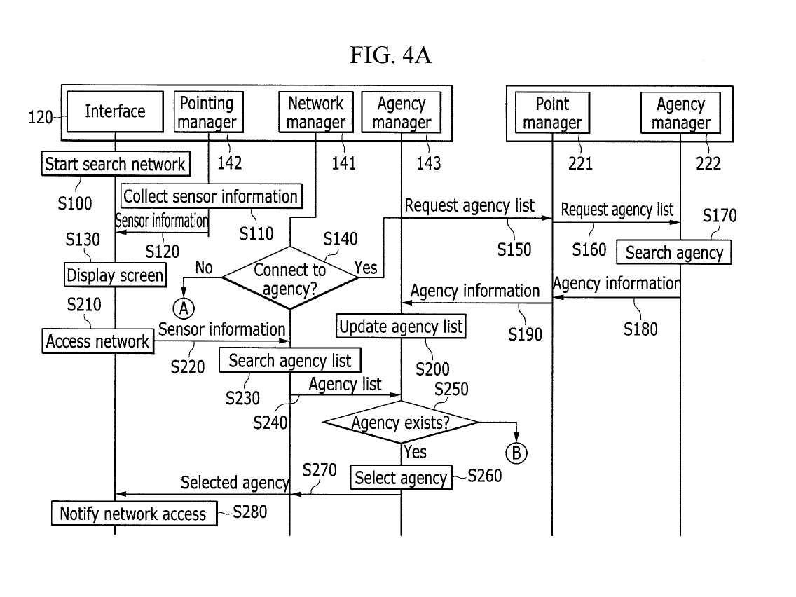

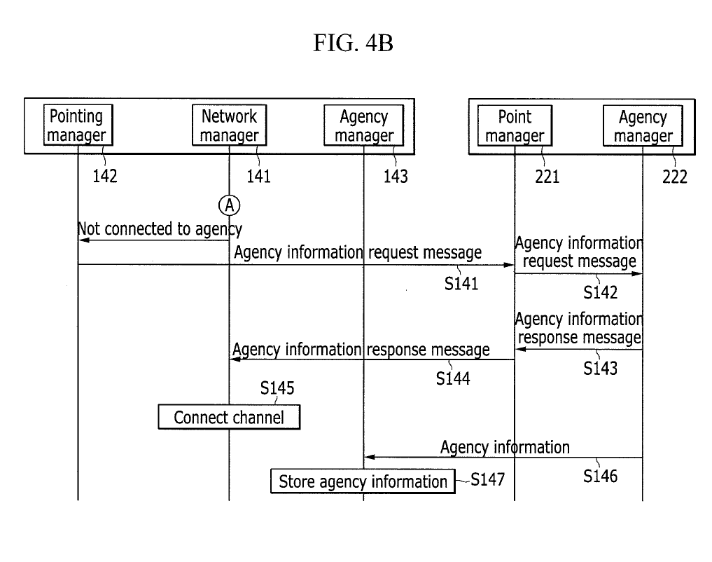

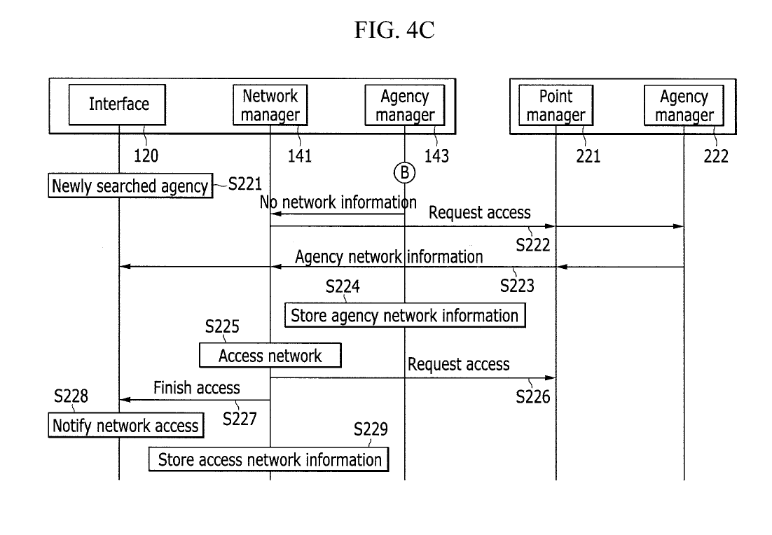

A method for a user to access a desired network under the system condition will now be described with reference to FIG. 4A to FIG. 4C.

FIG. 4A to FIG. 4C show flowcharts of a network access process according to a user direction according to an exemplary embodiment of the present invention.

As shown in FIG. 4A, the user starts searching networks accessible through the interface 120 of the terminal 100 (S100). The pointing manager 142 collects sensor information collected by the position information sensor 182, the bearing recognizing sensor 183, and the direction recognizing sensor 184 and transmits the same to the output unit installed in the terminal 100 (S120) to output current pointing information (S130). Here, the interface 120 is exemplified to perform a function of an output unit.

The network manager 141 determines whether the current terminal 100 is connected to an agency (S140). When the terminal 100 is connected to an agency, the network manager 141 requests a list of accessible agencies that are near the agency through the agency manager 143 based on the position information of the terminal 100 (S150). Here, the method for determining whether the terminal 100 is connected to an agency is well known to a person skilled in the art, and no detailed description thereof will be provided in the exemplary embodiment of the present invention.

When receiving a request on agency list from the terminal 100, the point manager 221 of the agency transmits it to the agency manager 222 (S160). The agency manager 222 searches agencies that are near and can be pointed to (S170), and transmits information on the searched agencies to the terminal 100 (S180 and S190). When receiving information on the agencies that can be pointed to from the agency manager 222, the terminal 100 updates the list of the agency manager 143 (S200). Here, the stages from S100 through S130 and the stages from S140 through S190 are described to be sequentially performed, and the present invention is not restricted thereto.

Hence, when the terminal 100 recognizes a network access intention through the user's direction (S210), the network manager 141 receives collected sensor information from the interface 120 (S220) and searches an appropriate agency from the agency manager 143 (S230). The agency manager 143 receives the agency list searched by the network manager 141 (S240) and determines whether the received agency list is in the agency manager 143 (S250).

When the agency list is in the agency manager 143, the agency manager 143 selects one of the searched agencies (S260) and notifies the user of it (S270). The interface 120 provides a notification message for notifying the network access to the user (S280).

When the terminal 100 is not connected to an agency according to the determination result of S140, information to be referred to for pointing cannot be checked as shown in FIG. 4B. Therefore, the pointing manager 142 broadcasts to the agency network or transmits an agency information request message including sensor information of the terminal 100 through multicasting (S141 and S142).

When one of a plurality of agencies receives the agency information request message and transmits an agency information response message to the network manager 141 (S143 and S144), the network manager 141 establishes a channel to communicate with an appropriate agency transmitted the agency information response message (S145). The network manager 141 receives information on neighboring agencies near to the appropriate agency from the agency manager of the appropriate agency (S146), and stores the same in the agency manager 143 (S147).

When the agency list received from the network manager 141 in the stage S250 of FIG. 4A is not in the agency manager 143, as shown in FIG. 4C, the agency appearing to the interface 120 is a newly searched agency that is not previously searched by the terminal 100 (S221) so the network manager 141 generates the pointing information into a message and requests agency information from the point manager 221 of neighboring agencies (S222). When receiving an agency network information message from the agency 200 appropriate for pointing information (S223), the agency manager 143 stores agency network information (S224).

When the user requests access to the corresponding network (S225), the network manager 141 requests a connection to the agency 200 by using the corresponding agency network ID (S226). When the terminal 100 is connected to the agency 200, the network manager 141 notifies an access finish (S227 and S228) and stores access network information in the network manager 141 so that another application program may recognize the currently accessed network (S229).

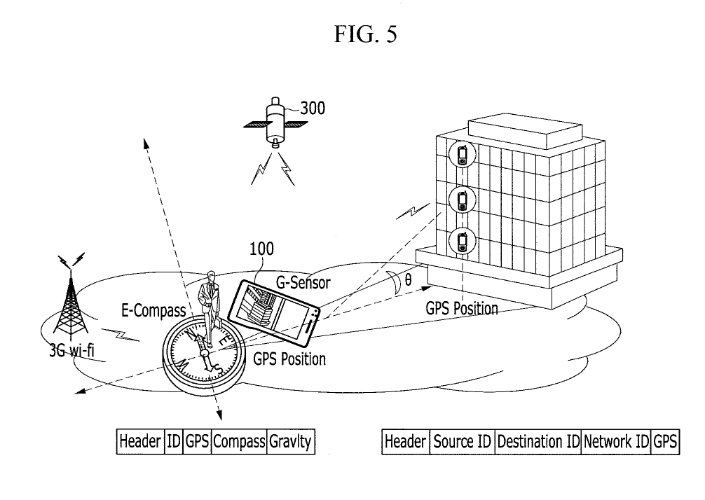

A case for accessing a network desired by the user through the above-described system will now be described with reference to FIG. 5 to FIG. 8.

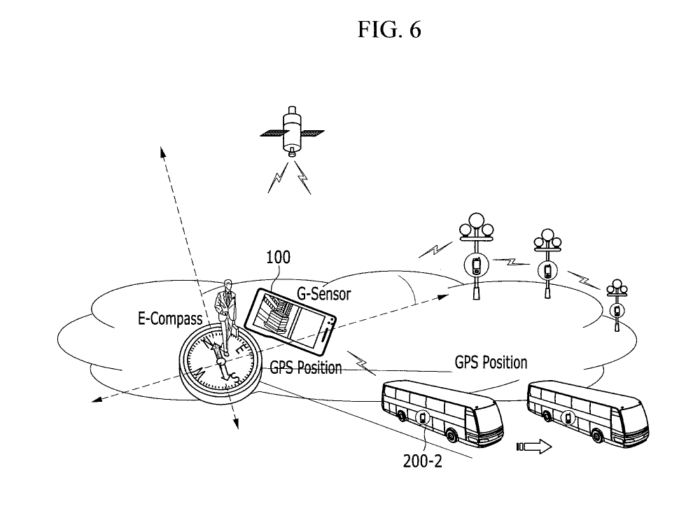

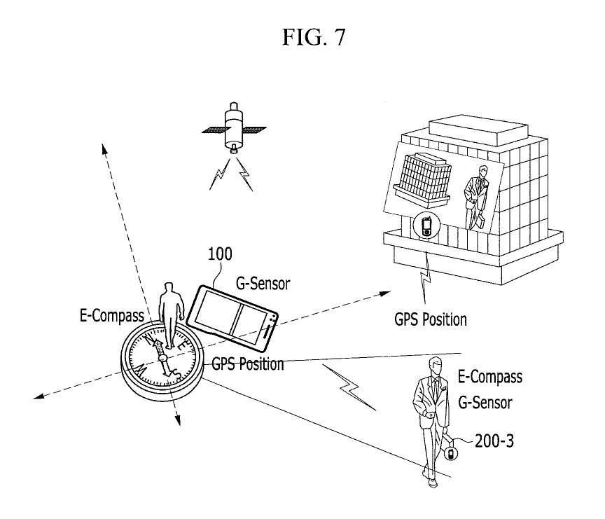

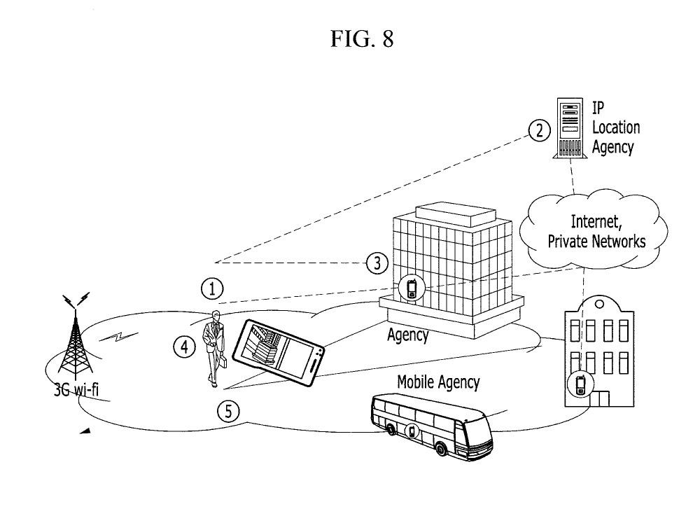

FIG. 5 shows an access to a desired network in a user direction according to an exemplary embodiment of the present invention, and FIG. 6 shows an access method of a mobile agency according to an exemplary embodiment of the present invention. FIG. 7 shows an access method to a social network supporting agency according to an exemplary embodiment of the present invention, and FIG. 8 shows an access method to an information protecting network in a user direction according to an exemplary embodiment of the present invention.

First, as shown in FIG. 5, in order for the user to access the desired network while heading the user direction, the terminal 100 includes an Internet connectable network, a position information sensor 182, a bearing recognizing sensor 183, and a direction recognizing sensor 184, and uses various messages to request and receive network position and network agency information.

Also, a message for providing network information is used to access the network, and the message represents a response message to be received by the terminal 100 from the agency when the terminal 100 requests pointing information from the agency. The purpose of pointing by the terminal 100 is to access the corresponding agency, so network information is provided to the terminal 100 so that the terminal 100 may access the network based on the network information.

Since many agencies are provided near the terminal 100, the sensors in the terminal 100 and the sensors in the agency 200 respectively detect the direction that points to the desired network and transmit an access request message to the agency that is installed in the desirable direction. That is, when the terminal 100 receives local agency information and stores the same in the agency management and storage unit 162 of the terminal 100 to update information, it can detect the direction pointed in by the network and transmit an access request message.

However, when the information is not updated, the terminal 100 includes sensor information including position information and direction information of the terminal 100 in a request message and transits it to the adjacent agencies. The agency having received the request message responds to the request message, and transmits the message presenting network information to the terminal 100 when the terminal 100 points to the agency. When having transmitted the access request message, the terminal 100 receives network information from the agency and accesses the agency.

In this instance, the terminal 100 can transmit and receive the message to and from the agency 200 though the currently accessed existing network such as the 3G network or the WiFi, and also can receive the same through the network available for direct communication with the agency. The terminal 100 and the agency detect the current position of the terminal 100 by using the position information providing system 300, acquire the direction pointed to by the terminal 100 by using a sensor such as a compass and a GPS bearing angle, and accordingly select the position of the desired agency.

When many agencies are positioned in the same direction, the desired agency is selected by determining the height of the agency so as to select the position of the desired agency to access by detecting the angle of the terminal 100 by using sensor information such as acceleration or angular velocity of the terminal 100.

It is needed to receive network information from the agency so as to access the network of the selected agency. For this purpose, the terminal 100 includes user directivity information acquired through the sensors in the terminal 100 in the network information request message and broadcasts it to the agencies or transmits it thereto through multicasting.

The agency provided at the position desired by the user compares position information of the agency and directivity information of the request message. When an agency (e.g. the closest agency to the terminal) is selected to be a network for the terminal 100 to access, the agency includes network connection information into a response message to the request message and transmits the response message to the terminal 100. Upon receiving the response message, the terminal 100 accesses the agency by using a network ID such as a service set identity (SSID) used to access the network. Here, the response message may include the SSID and information on the position, direction, and altitude of the selected agency.

The agency access method heading the user direction has been exemplified, and an access method by the mobile agency 200-2 will now be described with reference to FIG. 6.

FIG. 6 shows an access method of a mobile agency according to an exemplary embodiment of the present invention. As shown in FIG. 6, the terminal 100 indicates the direction of the mobile agency 200-2 by using position information, bearing information, and direction information of the terminal. The terminal 100 accesses the network provided by the mobile agency 200-2 that was provided at the position information when the direction is indicated.

In this instance, when the mobile agency 200-2 moves to another position, the acceleration sensor information and position information of the mobile agency 200-2 are analyzed. In preparation for the digression of the network range by the terminal 100, the initially pointed mobile agency 200-2 designates a second agency supporting a cooperation network and notifies the terminal 100 of the second agency. In this instance, the agency manager 222 determines whether the terminal 100 leaves the area covered by the agency manager 222.

When the network access intensity with the mobile agency 200-2 is weakened, the terminal 100 accesses a cooperation network of a third agency received from the initially pointed mobile agency 200-2. The service provided by the mobile agency 200-2 is provided to the terminal 100 through the cooperation network. When the mobile agency 200-2 leaves the access range of the cooperation network, it performs an access process with a second cooperation agency at the current position, and the terminal 100 receives a service.

The access method to the mobile agency 200-2 has been described, and an access method to a social network supporting agency 200-3 will now be described with reference to FIG. 7. FIG. 7 shows an access method to a social network supporting agency according to an exemplary embodiment of the present invention.

As shown in FIG. 7, the terminal 100 provides the function of the social network supporting agency 200-3. For example, it is assumed that there are two terminals. The terminals can check whether the social network is a member through the general agency 200-1 or the mobile agency 200-2 having a display. One terminal can transmit sensor information including position and direction information of the terminal to the agency by using a sensor for providing directivity of the terminal.

The other terminal having received sensor information checks sensor information of the user of the human network and provides network information in order for the terminal to access the social network supporting agency 200-3 and share personal contents. That is, the terminals connected with the social network can share sensor information such as position/direction of the terminals and perform pointing.

For example, when the users with the closest relationship meet each other within the radius in which they can be directly connected, they share their position and direction information and perform pointing. In this instance, when they are distant with each other and are out of the network access range, they can point to the agency with a display with directivity, access the same, and do entertainment such as games.

The access method to the social network supporting agency 200-3 has been described, and a connection to an unnamed network will now be described with reference to FIG. 8. FIG. 8 shows an unnamed network connecting method according to an exemplary embodiment of the present invention

As shown in FIG. 8, user information such as positions and directions of persons may be leaked through the network while terminal 100 selects an access agency through sensor information. Also, other competitive agencies may interfere with the service by falsely providing network information. To prevent this problem, the pointing manager 142 of the terminal 100 broadcasts or multicasts a temporary identifier known by the terminal 100 to the existing network or agency network so as to transmit personal information for acquiring network information.

The security agency encrypts a temporary IP for transmitting and receiving a message to/from the agency network or accessing the agency network into an identifier known by the user terminal, broadcasts it to the network, and broadcasts agency network information to the user terminal. When receiving the encrypted IP, the user terminal interprets it as a temporary identifier known by the user terminal, accesses the agency by using a network access IP, and starts receiving a network service.

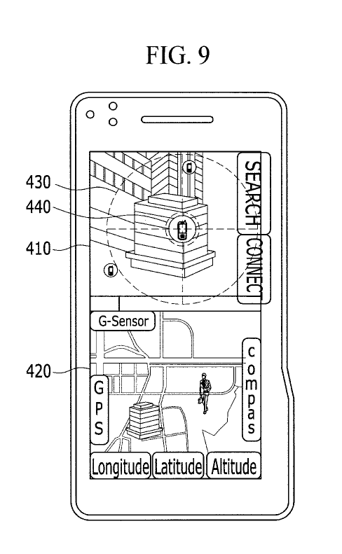

A GUI configuration of the terminal 100 will now be described with reference to FIG. 9.

FIG. 9 shows a configuration of a GUI of a user terminal according to an exemplary embodiment of the present invention.

As shown in FIG. 9, the terminal 100 includes a screen 410 displayed through a camera and a screen 420 for displaying information on the sensors for detecting the user direction. When the user requests an agency search function on the screen 410 viewable through the camera, a sight 430 in a target form for aiming at and selecting the agency is generated on the screen.

The network access function begins when the agency for accessing a small sight 440 is accurately matched, and agency network information is received to display the service provided by the current network. Here the target type sight 430 represents that there is one agency and pointing access is allowed with the one agency, and when many small sights are displayed as shown in FIG. 9, a desired one is precisely selected from among the displayed small sights and is then accessed.

Candidate agencies in addition to the selected agency are displayed to thus provide the user with an opportunity of selecting an agency included in the range of errors of the sensor. Information through the position information sensor includes GPS information such as longitude, latitude, and altitude provided in real-time, compass information is displayed through the bearing information sensor, and information on the top, bottom, and angle caused by the user direction is displayed through the direction information sensor.

Application services using a map service can be provided by marking the user direction and the agency position on the map through the user position information and the agency position information.

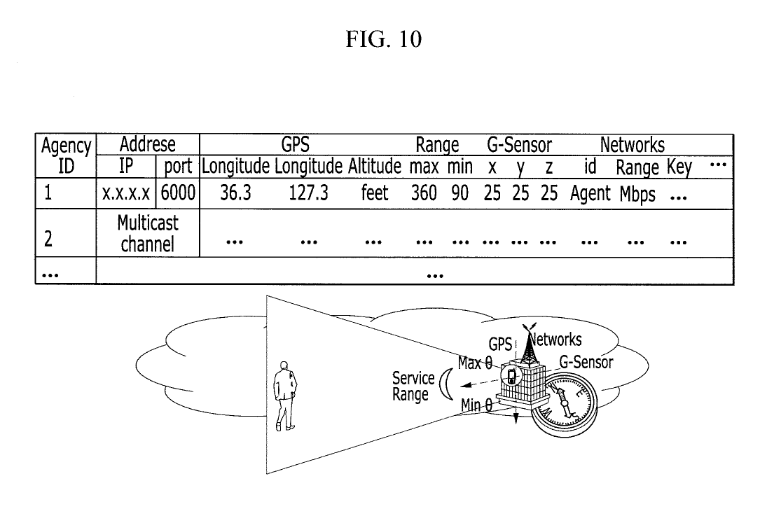

FIG. 10 shows a configuration of network information according to an exemplary embodiment of the present invention.

Each agency has an IP that is accessible through a proper identifier and port information. Agency information for detecting a position of the terminal 100 and a bearing and a distance of accessible agency network through position information of the agency is provided.

The agency may service the terminal before the blanket area such as a wall of a building, so it designates the service coverage range in the user direction from the corresponding position and has service range and direction sensor information for determining availability of network access. In this instance, the service range accessible by the terminal is expressed with a minimum direction angle and a maximum direction angle, and is configured with network information provided when it satisfies the user direction based on agency information.

Each agency has its own agency information, stores it in the agency list, and collects adjacent agency information, and when the user terminal requests a list, the agency downloads the list or receives the network request message desired by the user and provides network information when the network of the agency is appropriate.

According to embodiments of the present invention, the network access following the user direction provides a service for the user to intuitively and easily access from among many network candidates. Also, the user is directly connected to the desired network to minimize the network resource and provide a contents service.

Further, a mobile agency can detect changes of position information and sensor information and receive a service connected through collaboration between the agencies, and can provide different services through localization of private networks.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A terminal for accessing a network of an agency according to a user direction, comprising:
an information collector for collecting an agency image, agency information, and directivity information of a current user for providing an access process of an agency;
a manager for managing directivity information of the user, agency information, and network information collected by the information collector; and
an interlace for displaying information on the agency image collected by the information collector and the agency.

2. The terminal of claim 1, wherein
the information collector includes:
an access process checker for checking an access process to an agency positioned in the direction of the user by providing the collected agency image and the access process to the interface;
a position information sensor for collecting current position information from a position information providing system in cooperation with the terminal;
a bearing recognizing sensor for collecting bearing information of the current user; and
a direction recognizing sensor for collecting direction information of the user.

3. The terminal of claim 1, wherein
the manager includes:
a pointing manager for receiving the user's directivity information collected by the information collector to detect the user's directivity and manage directivity information, generating a temporary identifier, including the same in a request message, broadcasting the same to the agency, and decrypting a response message encrypted and transmitted by the agency;
an agency manager for managing accessible agency information and candidate network information based on the directivity information; and
a network manager for managing access to the corresponding network based on the network information managed by the agency manager or requesting a new network from the agency when there is no candidate network.

4. The terminal of claim 1, wherein the terminal includes:
an information storage unit for storing contents provided by the agency and information on the accessible agency; and
a network access unit for accessing a wireless network provided by the agency.

5. The terminal of claim 4, wherein
the information storage unit includes:
an agency management and storage unit for storing and managing information on the agency accessible by the user based on the user's directivity information; and
a file storage unit for receiving and storing the contents that are received by the agency manager from the agency.

6. The terminal of claim 4, further including:
an applier for receiving contents from the agency and providing them to the user; and
a controller for controlling the information collector, the manager, the interface, the information storage unit, the network access unit, and the applier.

7. An agency for providing a network for a terminal to access according to a user direction, comprising:
a user interface for managing current position information and contents to be provided to a terminal;
a manager for managing sensor information and terminal information provided by the terminal, managing contents to be provided to the terminal, and selecting and managing a substitute agency for providing contents to the terminal; and
an information provider for providing position information and bearing information of the agency to the terminal.

8. The agency of claim 7, wherein
the manager includes:
a point manager for receiving a request message including sensor information from a terminal pointing to the point manager, and storing and managing sensor information included in the request message and the terminal information;
an agency manager for managing neighboring agency information based on current position information; and
a contents manager for managing contents to be provided to the terminal, selecting a substitute agency for providing contents to the terminal when position information is changed, and transmitting a cooperation request message.

9. The agency of claim 7, wherein
the information provider includes:
a position information provider for collecting current position information from a position information providing system in linkage with an agency; and
a bearing information provider for collecting current bearing information.

10. The agency of claim 7, wherein the agency includes:
a network access unit for connecting a call of the terminal to communicate with the terminal; and
a controller for controlling the manager, the information provider, the user interface, and the network access unit.

11. A method for accessing a network of an agency according to a user direction, comprising:
collecting sensor information including user's position information, bearing information, and direction information;
requesting a list of accessible agencies near an agency for providing a network including the sensor information from the agency;
receiving a list of at least one accessible agency generated based on the sensor information from the agency;
searching whether there is an agency that satisfies the sensor information from among the agencies in the list; and
accessing the network through the agency when the agency satisfying the sensor information is found.

12. The method of claim 11, wherein the method includes,
after the searching:
when there is no agency satisfying the sensor information, broadcasting an agency information request message including the sensor information to a plurality of agencies that are positioned near the terminal;
receiving a response message on the broadcast agency information request message, and channel-connecting the agency having transmitted the response message;
receiving agency network information satisfying the user sensor information from the channel-connected agency;
requesting access to the network provided by the agency from the agency by using an agency network ID; and
when a connection to the network is finished, transmitting an access finish message to the agency that provides the network.

13. The method of claim 11, wherein
the requesting includes:
determining whether there is a connected network;
requesting the agency list when connected to a random network;
when not connected to a random network, broadcasting an agency information request message including the sensor information to a plurality of neighboring agencies;
receiving an agency information response message for the agency information request message from one of the plurality of agencies;
channel-connecting the agency having transmitted the agency information response message; and
receiving agency network information from the channel-connected agency and storing it.

14. The method of claim 11, wherein the method includes,
after the accessing:
receiving cooperation agency information for supporting a cooperation network designated by the agency based on agency sensor information of the agency;
when leaving the accessed network range, accessing the cooperation network provided by the cooperation agency; and
receiving contents through the cooperation network.
